(19) United States
(12) Patent Application Publication
(10) Pub. No.: US 2013/0347019 A1
(43) Pub. Date: Dec. 26, 2013

(54) METHOD FOR IMAGE PLAYBACK VERIFICATION

(71) Applicants: Gregory Charles Herlein, San Francisco, CA (US); Scott Russell Francis, Danville, CA (US); Eric Luke, Oakland, CA (US)

(72) Inventors: Gregory Charles Herlein, San Francisco, CA (US); Scott Russell Francis, Danville, CA (US); Eric Luke, Oakland, CA (US)

(73) Assignee: Thomson Licensing, Issy de Moulineaux (FR)

(21) Appl. No.: 14/003,039

(22) PCT Filed: Jan. 24, 2012
(86) PCT No.: PCT/US12/22295

§ 371 Date: Sep. 4, 2013

Related U.S. Application Data
(60) Provisional application No. 61/469,416, filed on Mar. 30, 2011.

(51) Int. Cl. H04N 21/81; H04N 21/24; H04N 21/414

(52) U.S. Cl. CPC H04N 21/812; H04N 21/414; H04N 21/24
USPC 725/22

(57) ABSTRACT

A process for verifying the playback of media content on a display includes receiving a digital representation of at least a portion of media content playing on the display, comparing the received digital representation to media content that was scheduled to play on the display from which the digital representation was captured and verifying the playback of the received digital representation if the received digital representation matches the compared media content. The process can further include soliciting a viewer of the display to capture a digital representation of at least a portion of the media content being presented on the display and to communicate the captured digital representation to an advertised location.

### CROSS-REFERENCE TO RELATED APPLICATIONS

This application claims the benefit of the filing date of the following U.S. Provisional Application Ser. No. 61/469,416, filed Mar. 30, 2011, hereby incorporated by reference in their entirety for all purposes:

### FIELD OF THE INVENTION

The present invention generally relates to media playback and, more particularly, to a method for providing proof of performance via image playback verification.

### BACKGROUND OF THE INVENTION

In media playback environments, such as retail advertising environments, verification systems are presently used to record all media playback events for in-store advertising systems. These verification systems are complex and operate to record the time and name of all media that plays on playback screens. For example, such systems use sensors in the playback equipment to monitor what is played and to log the playback results. These logs are then transmitted over a communications link to a central location for analysis and reporting to advertisers. This ‘proof of performance’ logging is critical to the value of the advertising. However, such systems used to monitor if the screens are operating properly and to record what is played on the screens and to then transmit that data to the central location are expensive and require operational staff. What is needed is a way to determine if the screens are playing the correct media without incurring the costs of the bandwidth to move the logs, or even to record the logs.

### SUMMARY OF THE INVENTION

Embodiments of the present invention address the deficiencies of the prior art by providing a method for image playback verification.

In an embodiment of the present invention a method for providing image playback verification includes capturing a digital representation of at least a portion of media content playing on an in-store video screen/display and communicating the captured digital representation to an advertised location. The method further includes comparing a received digital representation to images in media content that was scheduled to play on the screen from which the digital representation was captured at the time the digital representation was captured using information in the received digital representation regarding, for example, the date, time and location the digital image was captured. If the comparison results in a match, then playback of the media content compared to the received digital representation is verified to have played.

In an alternate embodiment of the present invention, the method includes soliciting a shopper to capture a digital image of media content playing on an in-store video screen and providing compensation or reward to the shopper for communicating the captured digital image to an advertised location.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising;

FIG. 3 depicts a flow diagram of a method for comparing images in accordance with an embodiment of the present invention;

FIG. 4 depicts an example of a screen presenting media in, for example, the content distribution system of FIG. 1 of which a user can capture a digital representation and transmit the digital representation to an advertised location in accordance with an embodiment of the present invention; and

FIG. 5 depicts a flow diagram of a method for image playback verification in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method for image playback verification. Although the present invention will be described primarily within the context of an in-store retail advertising network environment, the specific embodiments of the present invention should not be treated as limiting the scope of the invention. It will be appreciated by those skilled in the art and informed by the teachings of the present invention that the concepts of the present invention can be advantageously applied to any content distribution or communications network utilizing screens or displays to display media content, such as video-on-demand systems and the like.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

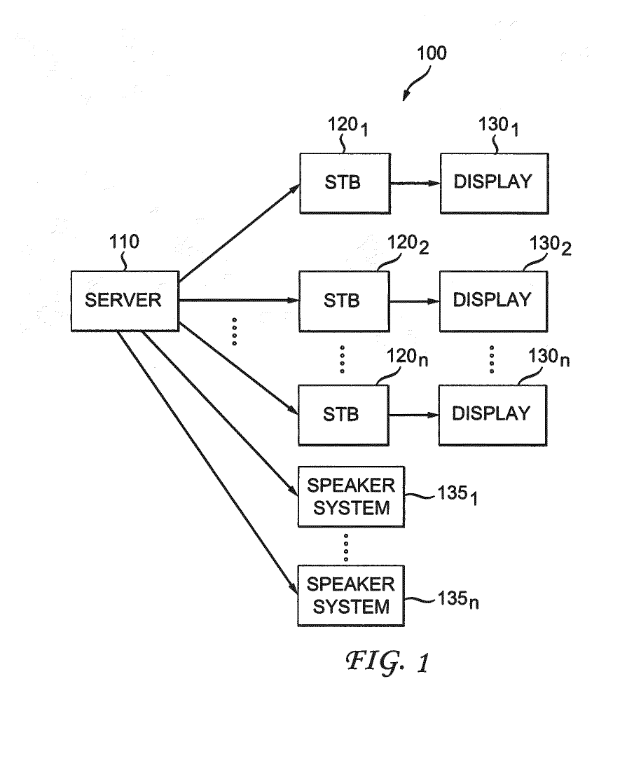

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

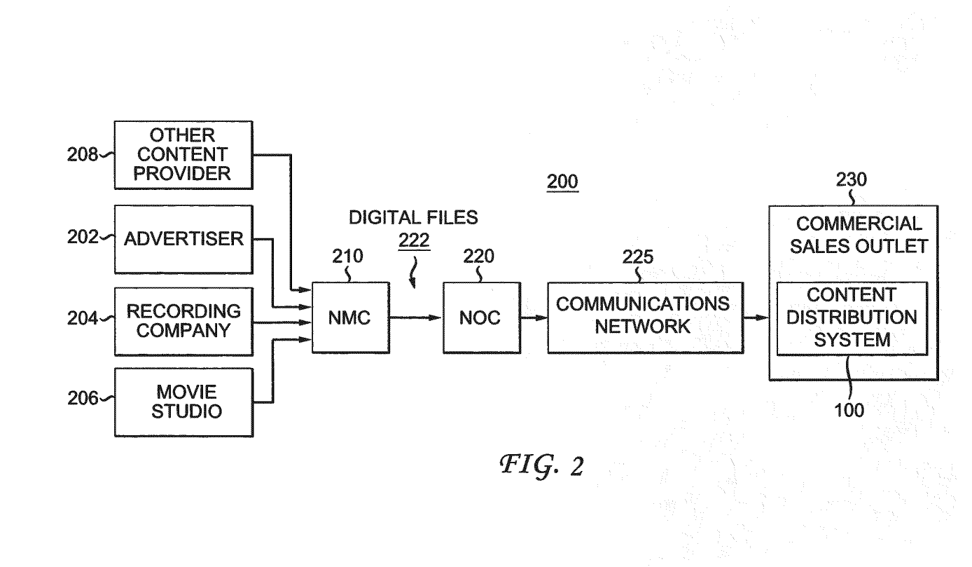

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130 and the speaker systems 135. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

The various embodiments of the present invention provide a method for image playback verification. In one embodiment of the present invention, a digital representation of at least a portion of media content playing on an in-store video display, such as the display 130 of a store containing the content distribution system 100 of FIG. 1 is captured using a mobile device, such as a digital camera or a mobile phone having a digital camera. In one embodiment of the present invention, the portion of the media content captured is captured in the form of a still image or digital picture. In alternate embodiments of the present invention, the portion of the media content captured can be captured as a media clip or video clip. In one embodiment of the present invention, the digital representation is captured using ‘geotagging’ enabled so that the date, time, and location of the digital images get recorded with the portion of the media content as it is captured.

The captured digital representation of the portion of the media content playing on the display 130 is then communicated to an advertised location. That is, in accordance with embodiments of the present invention, a location is advertised to which the captured digital representation can be sent. In one embodiment of the present invention, the location to which to send the captured digital image can be advertised on a display 130 of the content distribution system 100 or on other signage or can even be communicated directly to a mobile communication device of a user. The advertised location to which a digital representation can be sent can be a central location such as a server, for example the server 110 of the content distribution system 100 or the NMC 210 or the NOC 220 of the in-store advertising network 200. The transmission of the captured digital representation can be communicated to the central location using, for example, MMS or through email, or via some kind of ‘drop box’ file transfer. The communication of the digital representation to the central location can also be accomplished in one embodiment, using a smart phone, via the Internet or an intranet. In an alternate embodiment of the present invention, if a retail environment/store provides WiFi connectivity, that link can be used to communicate the captured digital representation to the central location.

Advantageously, however, in accordance with the concepts of the present invention, network connectivity provided by the content distribution system 100 or the in-store advertising network 200 is not required as a service provider of a mobile device used to capture the digital representation, or a related mobile device, can be used to communicate a captured digital representation to the central location.

At the central location, a received digital representation is compared to images in media content that was scheduled to play on the screen from which the digital representation was captured and, in one embodiment of the present invention, at the time the digital representation was captured using information in the received digital representation regarding, for example, the date, time and location the digital image was captured. If the comparison results in a match, then playback of the media content compared to the received digital representation is verified to have played. More specifically, at the central location, information is known about all media files/content that were programmed to be playing at all locations and on all screens, such as the displays of the content distribution system 100 in the in-store advertising network 200.

In one embodiment of the present invention, the media files are converted from full motion video to a set of discrete images for each video frame. Since video is usually 30 frames per second, this will result in at least 30 photo images for each second of video that is programmed to be displayed. In such an embodiment of the present invention, these images are stored at the central location and are indexed to know exactly which sets of images match the video files that are targeted to be played at each specific location (store or other advertising venue). In various embodiments of the present invention, metadata about a play-out location, such as a store, is also recorded at the central location including the date and time specific media files are programmed to be played on the displays of the venues, and the geographic location of each venue.

In one embodiment of the present invention, before processing for a match, each image frame is converted to phase space by applying the fast Fourier transform (FFT). This process needs to be applied only once per media clip image. The resulting phase space images are stored. The resulting data set is a large set of phase space images (stored as matrices) and no longer actual images.

As captured digital representations are received at the central location, they are processed to determine a match. In one embodiment of the present invention, to narrow an amount of images that have to be searched for a match, each captured digital representation is recorded in a database system to track from who it was provided, when, how, what time the digital representation was captured, and at what geographic location it was taken. As such, the store or venue that matches that location is identified. A set of programmed media files that were scheduled to have been playing on the matching display (or set of displays) is determined based on the programming information already available at the central location.

In accordance with various embodiments of the present invention, there are a number of options by which a captured digital representation of media content playing on a display can be matched to media content. In the case in which the captured digital image representation is a video clip, each frame of the captured video clip can be treated as a discrete image. It should be noted that lower video resolution video can result in some complexity that may make it harder to calculate a match, but that can be solved with HD video.

For matching a captured digital image representation of media playing on a display with known media content that is supposed to be playing on the display, in one embodiment of the present invention, the boundaries of the display from which the digital representation was captured are detected and that information is used to crop the digital representation. The cropped digital representation is then compared to a clip frame, determined as described above, using a simple image difference. Although affective, this approach can suffer from occluded screen boundaries, image distortions (such as glare), and even a slight tilting of the camera.

In an alternate embodiment of the present invention, like the media clip frames discussed above, a received captured digital representation is also transformed into phase space via an FFT. Once the captured digital representation is in phase space, the complex conjugate is determined to form the final basis image. That basis image is stored or held in memory for match processing. Standard image registration techniques (such as those from medical imaging) can then be used to compare the images. More specifically, cross-correlation in the frequency domain (phase space) can be used and the resulting phase map can be compared, in one embodiment, to a threshold to determine if two (or more) images match. Performing this computation in phase space requires significantly fewer computing resources than a cross correlation in normal space.

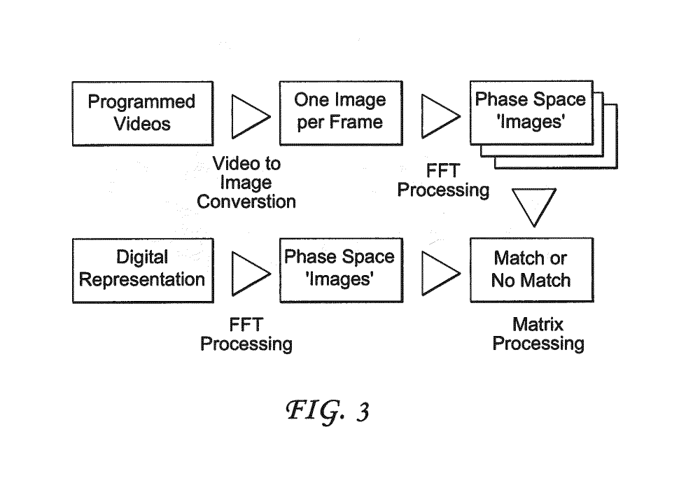

For example, FIG. 3 depicts a flow diagram of a method for comparing images in accordance with an embodiment of the present invention. As depicted in FIG. 3, programmed media content in the form of video is converted to image frames. The converted image frames (one per frame) are FFT processed and converted to phase space images. In the embodiment of FIG. 3, in parallel a received digital representation of images captured from media content playing on a display are also FFT processed and converted to phase space images. The phase space images are then compared as described herein to determine if a match exists.

In one embodiment of the present invention, the correlation between the photograph and a media clip image is computed by multiplying the two phase space images (as matrices) and normalizing the result. An inverse Fourier transform is applied to the result to obtain the final correlation map. This map takes the form of a 2D image composed of mostly zero values. However, if the media clip can be found anywhere in the captured digital image representation, the correlation map will contain a small region containing a “peak” of non-zero values. As the magnitude of these values indicate the degree of correlation between the two images, a simple thresholding approach can be utilized to determine if the match is successful. If the correlation map does not contain a value that exceeds the threshold (or if too many values exceed the threshold—i.e., the clip matches too many places, such as in the case of a blank frame), then it can be determined that the captured digital image representation does not contain the frame from the media clip. Note that while this method computes the parameters of an affine image transformation (translation, etc.), the approach does not use these values; rather, it simply provides a Boolean image matching test.

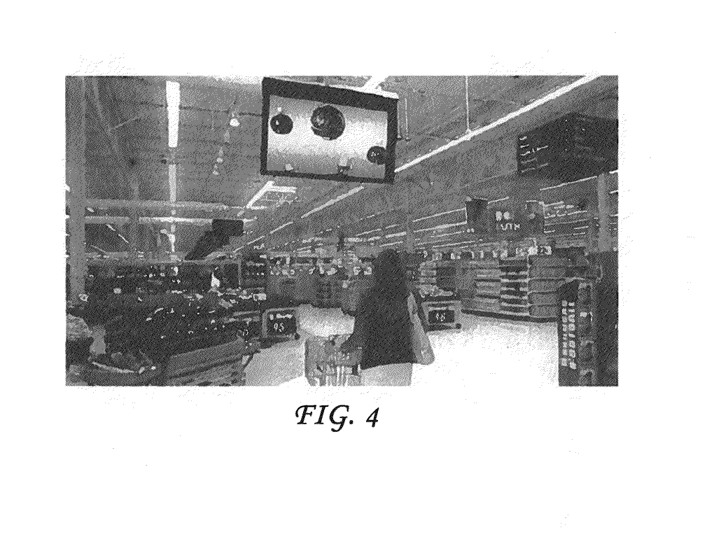

For example, FIG. 4 depicts an example of a screen presenting media in, for example, the content distribution system of FIG. 1 of which a user can capture a digital representation and transmit the digital representation to an advertised location in accordance with an embodiment of the present invention. In FIG. 4, the advertising screen is displaying a video advertisement. In accordance with an embodiment of the present invention, all video files programmed to play on that screen are broken down into discrete images, one per frame. All images are then converted to phase space and compared using matrix multiplication as described above. A resulting match confirms that the media was playing in that location at that time.

While the above described method of image registration is known to be computationally efficient, such method can be optimized further for even greater performance as follows:
1. Clip and captured digital representation images can be scaled down to geometrically reduce the amount of computations required (reducing the resolution by a factor of N reduces the computation by N². Since the method relies on phase difference between images (rather than control points), it is robust in the face of a moderate decrease in resolution.
2. Clip frames can be correlated in parallel against a captured digital representation image, making this approach a candidate for clustered or cloud-based hardware arrays.
3. Captured digital representation images can be correlated against representative clip frames (such as I-frames or an average of several frames) rather than individual frames, since the goal is media clip matching rather than individual frame matching.

Persons skilled in the art will realize that other methods of image processing are likewise possible, in accordance with the concepts of the present invention, to determine if a portion of a received captured digital representation image is a match for any of the images comprising the frames of all the video scheduled to play on a display at a venue.

In one embodiment of the present invention, the concepts of the present invention can include incentivizing shoppers to participate in capturing digital representations of media content playing on displays and communicating such digital representations to an advertised central location. More specifically, in one embodiment of the present invention, shoppers in a store containing the content distribution system 100 of FIG. 1 are solicited, for example, via a display 130 or other signage, to use their mobile devices, such as digital cameras and mobile phones having digital cameras, to capture a digital representation of at least a portion of media content playing on the displays 130 in various locations of the content distribution system 100. In one embodiment of the present invention, the shoppers are encouraged to capture a digital representation with ‘geotagging’ enabled so that the date, time, and location of the digital representation get recorded with the digital representation as it is captured.

In accordance with the present invention, a location is advertised to which a shopper can send the captured digital representation. In one embodiment of the present invention, the location to which to send the captured digital representation can be advertised on a screen of the content distribution system 100 or on other signage or can even be communicated directly to a shopper on a mobile communication device of the shopper. The location can be a central location such as a server, for example the server 110 of the content distribution system 100 or the NMC 210 or the NOC 220 of the in-store advertising network 200. The transmission of the captured digital representation can be communicated to the central location by a shopper using, for example, MMS or through email, or via some kind of ‘drop box’ file transfer. The communication of the digital representation to the central location can also be accomplished in one embodiment, using a smart phone, via the Internet or an intranet. In an alternate embodiment of the present invention, if a retail environment/store provides WiFi connectivity, that link can be used to communicate the captured digital representation to the central location. Advantageously, however, in accordance with the concepts of the present invention, network connectivity provided by the content distribution system 100 or the in-store advertising network 200 is not required as a service provider of the mobile device used to capture the digital representation or a related mobile device can be used to communicate a captured digital representation to the central location.

At the central location, a received digital representation is compared to images in media content that were scheduled to play on the screen from which the digital representation was captured at the time the digital representation was captured as described above.

In exchange for taking the digital representation and communicating it to the central location, the shopper can be offered some kind of reward or compensation, or a chance for such. Note that in such an embodiment, the effort for capturing the digital representation was exerted by the shopper and that the shopper is paying the bandwidth to send the captured digital representation using, for example, resources and services provided via their mobile device. If an in-store environment provides WiFi connectivity, that link can also be used to communicate the captured digital representation to the central location. However, the network connectivity provided by the content distribution system 100 or the in-store advertising network 200 is not required in such an embodiment of the present invention.

In yet an alternate embodiment of the present invention, a user or technician of the content distribution system 100 or the in-store advertising network 200 can utilize the concepts of the present invention to capture a digital representation of media content playing on displays in various locations of a content distribution system and communicate the captured digital representation to a central location as described above.

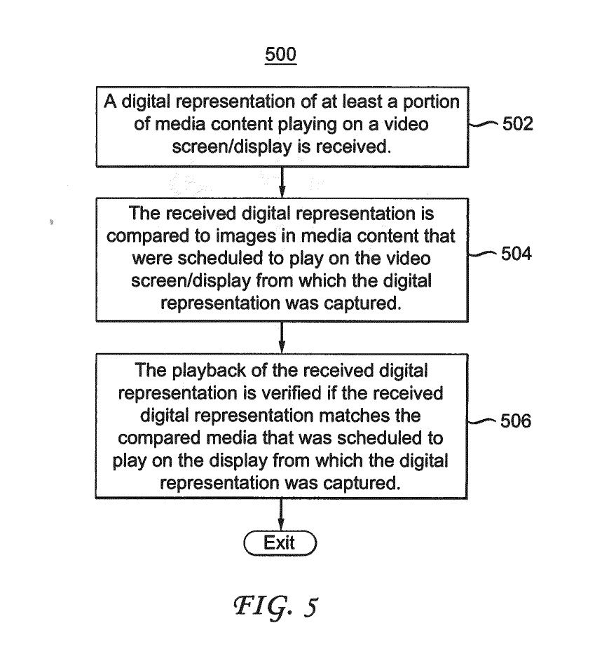

FIG. 5 depicts a flow diagram of a method for image playback verification in accordance with an embodiment of the present invention. The method 500 of FIG. 5 begins at step 502 during which a digital representation of at least a portion of media content playing on a video screen/display is received. The method 500 then proceeds to step 504.

At step 504, the received digital representation is compared to images in media content that were scheduled to play on the video screen/display from which the digital representation was captured, for example in one embodiment, at the time the digital representation was captured. The method 500 then proceeds to step 506.

At step 506, the playback of the received digital representation is verified if the received digital representation matches the compared media that was scheduled to play on the display from which the digital representation was captured.

The method 500 is then exited.

Having described various embodiments of a method for image playback verification (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for image playback verification, comprising:
receiving a digital representation of at least a portion of media content playing on a display;
comparing the received digital representation to media content that was scheduled to play on the display from which the digital representation was captured; and
verifying the playback of the received digital representation if the received digital representation matches the compared media content.

2. The method of claim 1, wherein the received digital representation of at least a portion of media content playing on a display is captured using a digital camera.

3. The method of claim 2, wherein the received digital representation of at least a portion of media content playing on a display comprises at least one of a still image, a digital picture, a media clip and a video clip.

4. The method of claim 1, wherein the received digital representation of at least a portion of media content playing on a display is captured such that at least one of a date, a time, and a location of a playback of the digital representation is recorded.

5. The method of claim 1, further comprising advertising a location to which the digital representation of at least a portion of media content playing on a display is to be communicated.

6. The method of claim 5, wherein said location is advertised on the display.

7. The method of claim 1, wherein said location is advertised on a display of a user's mobile communication device used to communicate the digital representation of at least a portion of media content playing on the display.

8. The method of claim 1, wherein the digital representation of at least a portion of media content playing on a display is received via at least one of a multimedia messaging service, email, a drop-box file transfer, an intranet, wireless communications and the Internet.

9. The method of claim 1, wherein the digital representation of at least a portion of media content playing on a display is captured and communicated using a mobile communications device.

10. The method of claim 1, comprising reducing media content compared to the received digital representation by comparing only media content scheduled to be displayed on the display proximate to the time the digital representation was captured.

11. The method of claim 1, wherein information regarding at least one of a location, a date and a time that media content is programmed to be played on specific displays is known.

12. The method of claim 1, wherein said comparing comprises converting at least one of the media content and the received digital representation to a set of discrete images for each video frame.

13. The method of claim 12, wherein said comparing comprises converting at least one image frame to phase space by applying the fast Fourier transform.

14. The method of claim 13, wherein a large set of phase space images is stored as matrices.

15. The method of claim 13, wherein said comparing further comprises using cross-correlation in the frequency domain to determine if two or more images in phase space match.

16. The method of claim 13, wherein the compared media content and the received digital representation are converted to phase space and a correlation between the phase spaces is computed by multiplying the two phase space images as matrices, normalizing the result and applying an inverse Fourier transform to a result to obtain a final correlation map.

17. The method of claim 16, wherein if the final correlation map comprises zero values then there is no correlation and if the final correlation map comprises a peak of non-zero values then there exists a correlation.

18. The method of claim 1 further comprising scaling down the resolution of the received digital representation to geometrically reduce an amount of computations required for the comparing step.

19. The method of claim 1, further comprising detecting the boundaries of the display from which the digital representation was captured are detected and using the boundary information to crop the digital representation for improving the comparison with the media content that was scheduled to play on the display from which the digital representation was captured.

20. The method of claim 1, further comprising incentivizing shoppers to participate in capturing digital representations of media content playing on displays and communicating such digital representations to an advertised location.

21. A method for image playback verification, comprising:
soliciting a viewer of a display to capture a digital representation of at least a portion of the media content being presented on the display and to communicate the captured digital representation to an advertised location;
receiving, at the advertised location, said digital representation of at least a portion of media content playing on the display;
comparing the received digital representation to media content that was scheduled to play on the display from which the digital representation was captured; and
verifying the playback of the received digital representation if the received digital representation matches the compared media content.
